(19) United States
(12) Patent Application Publication
(10) Pub. No.: US 2008/0199171 A1
(43) Pub. Date: Aug. 21, 2008

(54) IMAGING DEVICE

(76) Inventors: Rei Yoshida, Nagano (JP); Hiroaki Furuya, Nagano (JP); Hiroshi Miyazawa, Nagano (JP)

Correspondence Address: Frank Pincelli;Patent Legal Staff, Eastman Kodak Company, 343 State Street, Rochester, NY, 14650-2201, US

(21) Appl. No.: 11/763,466

(22) Filed: Jun. 15, 2007

(30) Foreign Application Priority Data
Feb. 15, 2007 (JP) 2007-035409

(51) Int. Cl. G03B 15/03

(52) U.S. Cl. 396/157

(57) ABSTRACT

In order to appropriately measure light during preliminary light emission, regardless of an imaging sensitivity during imaging in an imaging device which measures light during preliminary light emission based on an image signal which is output from an imaging unit based on reflected light from an object, and calculates an amount of main light emission during imaging based on the measurement result, an imaging unit outputs an image signal which is amplified by an amplification corresponding to an imaging sensitivity based on object light. A strobe controller measures reflected light from an object during preliminary light emission which is executed prior to the main light emission during imaging based on an image signal which is output by the imaging unit based on the reflected light, and calculates an amount of main light emission for the main light emission based on the measurement result. The strobe controller sets an amount of light emission for the preliminary light emission based on the imaging sensitivity during the imaging.

### CROSS REFERENCE TO RELATED APPLICATIONS

This application claims priority to Japanese Patent Application No. 2007-35409 filed on Feb. 15, 2007, which is incorporated herein by reference in its entirety.

### FIELD OF THE INVENTION

The present invention relates to an imaging device in which a preliminary light emission is executed before a main light emission during imaging, reflected light from an object is measured, and an amount of light emission of the main light emission is calculated based on the measurement result.

### BACKGROUND OF THE INVENTION

In the related art, a TTL dimming method is employed in which an amount of light emission is controlled using imaging light through an imaging lens, as a control method of a flash light emitter of a digital camera or a silver halide film camera. Among the cameras which apply TTL dimming, there exist cameras in which a preliminary light emission is executed before the main light emission during imaging, reflected light from an object is measured, and information for the main light emission is obtained. In such cameras, by measuring the reflected light of the preliminary light emission before imaging and executing the calculation, it is possible to realize TTL dimming in a structure which cannot measure the reflected light from the object during the main light emission using the TTL method.

In some digital cameras having an imaging unit including a solid-state imaging element such as a CCD, light is measured during the preliminary light emission based on an image signal which is output from the imaging unit, an amount of light emission necessary for the main light emission is calculated from the measurement result of the preliminary light emission, and main light emission is executed with the calculated amount of light emission. By constructing a camera in this manner, the solid-state imaging element such as the CCD can also be used as a controlling sensor for the flash light emitter, which is advantageous in reducing, for example, the cost.

JP 2006-53493A discloses a technique in which amplification of an image signal which is output from the imaging unit during measurement of the preliminary light emission is varied depending on a distance to an object (hereinafter referred to as “object distance”).

While the amount of light of the flash light emitter is reduced as the distance to the object is increased, as the imaging sensitivity which is an index for the amplification or the like of the image signal is increased, an appropriate exposure can be obtained even if the illumination light of an object is weak, and thus the object distance at which the main light emission of the flash light emitter is effective becomes longer as the imaging sensitivity is increased. In addition, in general, in order to secure a necessary amount of light emission for the main light emission, the amount of light emission of the preliminary light emission is set in advance to an amount which is smaller than the amount of light emission for the main light emission. When a user manually sets the imaging sensitivity during the imaging, for example, there may be cases, depending on the set imaging sensitivity, where the light cannot be appropriately measured because the preset amount of light emission of the preliminary light emission is too small. In other words, although the increase in the imaging sensitivity corresponds to an increase in the amplification of the output signal of the imaging element, such an increase also results in an increase in noise level, and consequently reduction in the dynamic range of the output signal. When the actual image signal is output during the main light emission, this influence is small. However, in the preliminary light emission having a smaller amount of light emission, the influence of the reduction of the dynamic range is relatively increased even when the amplification is similarly increased, resulting in a significant reduction in precision of a light measurement value by the output signal of the imaging unit.

An object of the present invention is to precisely and appropriately measure light during preliminary light emission regardless of the imaging sensitivity during the imaging, in an imaging device in which light is measured based on an image signal which is output from the imaging unit based on reflected light from an object during a preliminary light emission, and an amount of main light emission during imaging is calculated based on a result of the light measurement.

### SUMMARY OF THE INVENTION

According to one aspect of the present invention, there is provided an imaging device comprising an imaging unit which amplifies an image signal which is obtained by opto-electric conversion of imaging light from an object with an amplification corresponding to an imaging sensitivity which is set in advance, and outputs the amplified image signal, a main light emission amount calculator which measures reflected light from the object based on an image signal corresponding to the reflected light from the object which is output by the imaging unit during a preliminary light emission which is executed before the main light emission during imaging, and calculates an amount of main light emission during the main light emission based on a result of the light measurement, and a preliminary light emission amount setting unit which sets an amount of preliminary light emission during the preliminary light emission based on the imaging sensitivity during imaging which is set in advance.

According to another aspect of the present invention, it is preferable that, in the imaging device, the preliminary light emission amount setting unit sets the amount of preliminary light emission such that an amount of light emission is increased as the imaging sensitivity during imaging is increased.

According to another aspect of the present invention, it is preferable that the imaging device further comprises an imaging sensitivity setting unit which sets an imaging sensitivity during the preliminary light emission according to the amount of preliminary light emission.

According to various aspects of the present invention, it is possible to appropriately measure light during the preliminary light emission regardless of the imaging sensitivity during imaging. Therefore, the amount of main light emission which is calculated based on a measurement result in the preliminary light emission can be appropriately calculated, and an image can be captured with an appropriate exposure.

### BRIEF DESCRIPTION OF THE DRAWINGS

Preferred embodiments of the present invention will be described in detail with reference to the drawings, wherein:

FIG. 1 is a diagram showing a functional block of an imaging device according to a preferred embodiment of the present invention;

FIG. 2 is a diagram exemplifying a reference table which is referred to when a strobe controller sets an imaging sensitivity and an amount of light emission during a preliminary light emission; and

FIG. 3 is a flowchart showing a process when an imaging device according to a preferred embodiment of the present invention captures an image in response to an instruction from a user.

### DESCRIPTION OF EXEMPLARY EMBODIMENT

A preferred embodiment of the present invention will now be described with reference to the drawings.

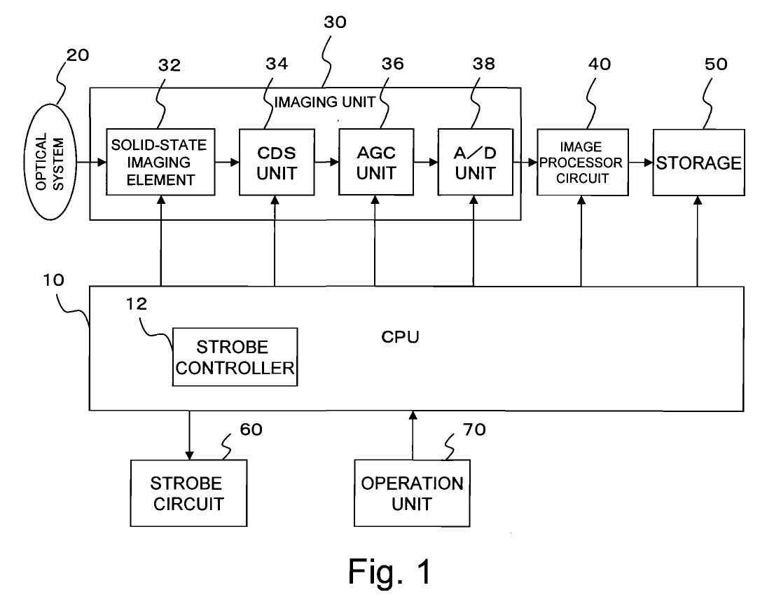

FIG. 1 is a diagram showing a functional block of an imaging device according to a preferred embodiment of the present invention. In FIG. 1, a CPU 10 is a central processing unit which controls the overall imaging device, and applies calculation processes and controls to circuits or the like of the imaging device. An optical system 20 includes a lens, a diaphragm, etc. for allowing light from an object to be incident on an imaging unit 30 in order to obtain a desired video signal.

The imaging unit 30 comprises a solid-state imaging element 32 such as a CCD or CMOS which vertically transfers or horizontally transfers an image signal generated as a result of opto-electric conversion of incident light. The imaging unit 30 further comprises a CDS unit 34, an AGC unit 36, and an A/D unit 38. The CDS unit 34 applies correlated double sampling to an analog image signal which is output from the solid-state imaging element 32, to remove noise. The AGC unit 36 amplifies an image signal which is output from the CDS unit 34 with an amplification according to an imaging sensitivity (such as, for example, an ISO sensitivity). The A/D unit 38 converts the amplified analog image signal into a digital signal and outputs the digital signal to an image processor circuit 40.

The image processor circuit 40 applies a predetermined image process such as a white balance process, a pixel interpolation process, and an edge process with respect to an image signal which is output from the imaging unit 30, and stores image signals of one frame in a storage 50 as image data.

Under control of a strobe controller 12 of the CPU 10, a strobe circuit 60 executes preliminary light emission having a small amount of light on an object at a time prior to the imaging and executes main light emission having an amount of light emission which is greater than the amount of preliminary light emission on the object to achieve an appropriate exposure for the imaging. An operation unit 70 is a user interface to allow a user to operate the imaging device such as, for example, a shutter button and an operation button for setting the imaging sensitivity.

In an imaging device of the present embodiment having such a structure, the strobe controller 12 measures an amount of reflected light from an object using an imaging signal that is based on the reflected light from the object and which is output from the imaging unit 30 during preliminary light emission, and calculates an amount of main light emission during imaging based on the measurement result. The calculation of the amount of the main light emission may be performed with any method so long as the method calculates the amount of main light emission based on the image signal which is output by the solid-state imaging element 32 during the preliminary light emission.

The strobe controller 12 also sets an amount of preliminary light emission during the preliminary light emission, with an imaging sensitivity during imaging as a parameter. For example, a larger imaging sensitivity during the imaging which is set by the user corresponds to a longer object distance at which light is effective for the imaging during the main light emission of the strobe. Because of this, when the imaging sensitivity is increased, reflected light of an object at a farther distance must be received by the solid-state imaging element 32 for light measurement.

In order to receive the reflected light of an object at a farther distance, it is effective to increase the amplification of the image signal which is output from the solid-state imaging element 32 based on the imaging sensitivity. In other words, it is effective to increase the imaging sensitivity during the preliminary light emission in a manner similar to the imaging sensitivity during the main light emission. However, when the imaging sensitivity is too large, the dynamic range of the solid-state imaging element 32 is narrowed due to an increase in noise, and in particular, there is a possibility that the precision of light measurement based on the image signal during the preliminary light emission having a smaller amount of light emission may be reduced.

In the present embodiment, the amount of preliminary light emission is increased to a degree that does not affect the main light emission according to an increase in the imaging sensitivity during the imaging, and the imaging sensitivity during the preliminary light emission is increased to such a degree that any error in the light measurement due to the influence of noise or the like can be tolerated.

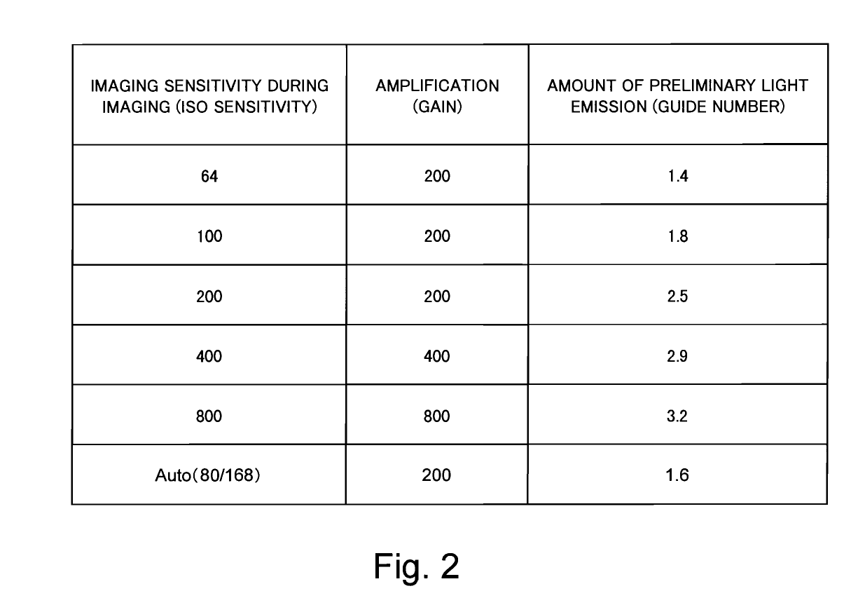

The strobe controller 12 may store, for example, a reference table as shown in FIG. 2 in a memory in advance, and may refer to the reference table to determine the amount of preliminary light emission (guide number) and the imaging sensitivity (amplification) corresponding to the imaging sensitivity for the imaging which is set by the user.

The amount of preliminary light emission and the imaging sensitivity during preliminary light emission corresponding to the magnitude of the imaging sensitivity during the imaging may be determined through experiments or the like. More specifically, for example, for each imaging sensitivity which can be set as the imaging sensitivity during imaging, the amount of preliminary light emission and the imaging sensitivity are set at a plurality of values and light is measured. Then, images are captured at the amounts of main light emission calculated based on the measurement results. The images obtained as a result are compared, and an image with the best image quality is selected for each imaging sensitivity during imaging. The amount of preliminary light emission and the imaging sensitivity corresponding to the selected image are correlated with the imaging sensitivity during the imaging, to create a reference table as shown in FIG. 2. In FIG. 2, “Auto” indicates a case in which the imaging sensitivity during the imaging is automatically set by the imaging device based on a brightness of an object or the like, instead of the imaging sensitivity during the imaging being manually set by the user. In other words, when the imaging sensitivity during the imaging is automatically set, the amount of preliminary light emission and the imaging sensitivity corresponding to “Auto” are set during the preliminary light emission.

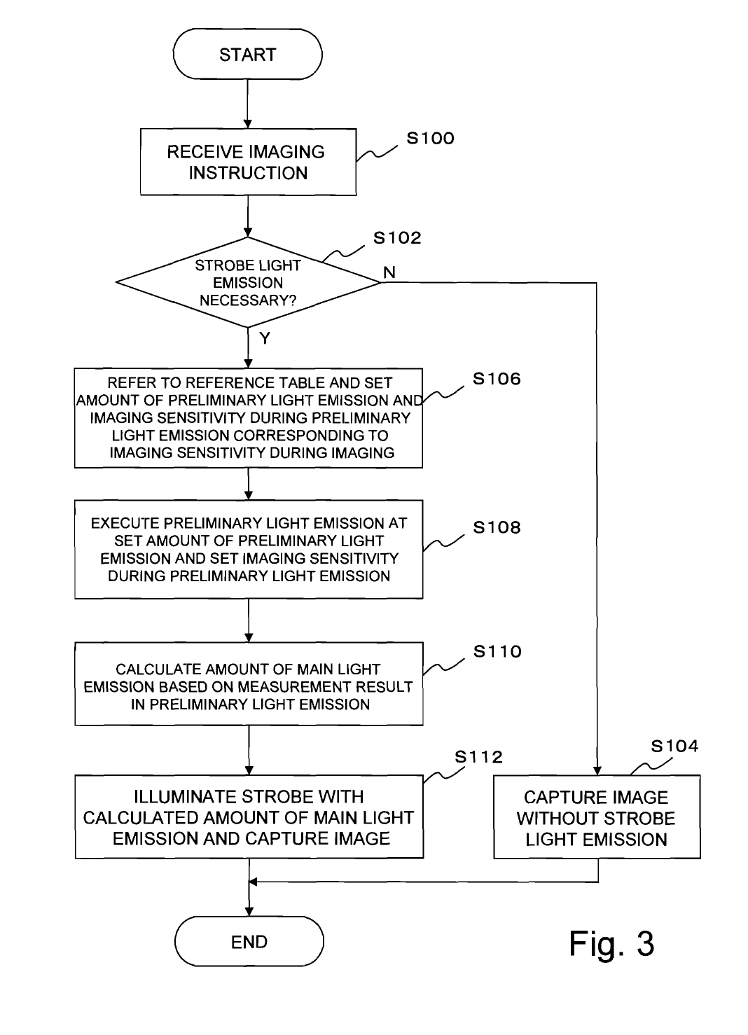

FIG. 3 is a flowchart showing a process when an imaging device according to the present embodiment captures an image in response to an instruction by a user.

In FIG. 3, the imaging device receives an imaging instruction in response to, for example, the user pressing the shutter button all the way down (S100). Then, the imaging device determines a brightness of an object based on an image signal or the like which is output from the imaging unit 30, and determines whether or not the strobe light emission is necessary based on the brightness of the object (S102). When it is determined as a result of the determination that the strobe light emission is not necessary (no or “N” in the determination result of step S102), the imaging device captures an image of the object without the strobe light emission (S104).

On the other hand, when it is determined that the strobe light emission is necessary (yes or “Y” in the determination result of step S102), the imaging device refers to the reference table and sets the amount of preliminary light emission and the imaging sensitivity during the preliminary light emission corresponding to the imaging sensitivity during imaging (S106). Then, the imaging device executes the preliminary light emission (S108) at the set amount of preliminary light emission and the set imaging sensitivity, and calculates the amount of main light emission (S110) based on the measurement result in the preliminary light emission. Next, the imaging device illuminates the strobe with the calculated amount of main light emission and captures an image (S112).

As described, according to the present embodiment, light measurement during the preliminary light emission can be appropriately executed regardless of the imaging sensitivity during the imaging. Thus, the calculation of the amount of main light emission which is executed based on the measurement result in the preliminary light emission can be appropriately executed and an image can be captured with an appropriate exposure.

### Parts List

10 CPU

12 strobe controller

20 optical system

30 imaging unit

32 imaging element

34 CDS unit

36 AGC unit

38 A/D unit

40 image processor circuit

50 storage

60 strobe circuit

70 operation unit

S100 receive imaging instruction

S102 strobe light emission determination

S104 no strobe light emission

S106 preliminary light emission

S108 execute preliminary light emission

S110 main light emission calculation

S112 illuminate of strobe

What is claimed is:

1. An imaging device comprising:
an imaging unit which amplifies an image signal which is obtained by opto-electric conversion of imaging light from an object with an amplification corresponding to an imaging sensitivity which is set in advance, and outputs the amplified image signal;
a main light emission amount calculator which measures reflected light from the object based on an image signal corresponding to the reflected light from the object which is output by the imaging unit during preliminary light emission which is executed before the main light emission during imaging, and calculates an amount of main light emission during the main light emission based on a result of the light measurement; and
a preliminary light emission amount setting unit which sets an amount of preliminary light emission during the preliminary light emission based on the imaging sensitivity during imaging which is set in advance.

2. The imaging device according to claim 1, wherein
the preliminary light emission amount setting unit sets the amount of preliminary light emission such that an amount of light emission is increased as the imaging sensitivity during imaging is increased.

3. The imaging device according to claim 1 further comprising:
an imaging sensitivity setting unit which sets an imaging sensitivity during the preliminary light emission according to the amount of preliminary light emission.
